(19) United States
(12) Patent Application Publication
(10) Pub. No.: US 2016/0375980 A1
(43) Pub. Date: Dec. 29, 2016

(54) FUSELAGE SKIN WINDOW UNIT FOR AN AIRCRAFT

(71) Applicant: Airbus Operations GmbH, Hamburg (DE)

(72) Inventor: Dimitri Orlov, Hamburg (DE)

(73) Assignee: Airbus Operations GmbH, Hamburg (DE)

(21) Appl. No.: 15/189,148

(22) Filed: Jun. 22, 2016

(30) Foreign Application Priority Data
Jun. 24, 2015 (DE) 10 2015 110 165.3

(51) Int. Cl. B64C 1/14

(52) U.S. Cl. CPC B64C 1/1484; B64C 1/1492

(57) ABSTRACT

A fuselage skin window unit for an aircraft, an aircraft with such a fuselage skin window unit and a method for manufacturing such a fuselage skin window unit are described. The fuselage skin window unit includes a fuselage skin section and a window pane section. The fuselage skin section is part of a fuselage skin of the aircraft and has a pattern of pinhole perforations. The window pane section is transparent and arranged so that it covers the pinhole perforations.

### FIELD OF THE INVENTION

The invention relates to a fuselage skin window unit for an aircraft, an aircraft with such a fuselage skin window unit and a method for manufacturing such a fuselage skin window unit.

### BACKGROUND OF THE INVENTION

Conventional aircraft window normally comprise a window frame, an outer and an inner window pane, seals, a holding element and connection elements to connect with the aircraft. The outer and inner window pane and the seals together form a so-called window set. The outer window integrated within the window pane takes in flight operations only those loads which result from a difference in pressure between the interior of the airplane cabin and the environment. All other loads that occur in the fuselage structure are led around a window recess inter alia by means of a reinforcing window frame.

DE 10 2008 007 545 A1 describes a window for an airplane, the window being made of a transparent composite material, wherein the composite material comprises fibers and a matrix material, so that the vehicle window is able to take loads occurring in the area of the window and to provide the window function in spite of damage to the vehicle window. The fibers and the matrix material are transparent and have essentially the same refractive index.

### BRIEF SUMMARY OF THE INVENTION

There may be a need for an alternative fuselage skin window unit for an aircraft.

It is proposed to provide a fuselage skin window unit for an aircraft which comprises a fuselage skin section and a window pane section. The fuselage skin section is part of a fuselage skin of the aircraft and has a pattern of pinholes perforations. The window pane section is transparent and arranged so that it covers the pinholes perforations.

The term “pinhole perforations” is to be understood as comprising many small holes in a surface. The term “pattern of pinhole perforations” is to be understood as the arrangement of the many small holes in the surface in such a manner that the holes have the effect that the surface appears transparent for a relatively close person. The term ‘close’ refers in this context to the usual distances between an air passenger vehicle and a wall of the aircraft. For a more distant person the surface will appear opaque. This effect is utilized with pinhole foils or window graphics for advertising purpose on buses, for example. The bus passenger looks almost freely to the outside, while a person located outside the bus and with greater distance to the bus perceives an advertising print on the bus. The term “pinhole perforations” does not mean that the pinhole perforations are actually made by needles or that the hole size and other dimensions must be compatible with needles.

In the present description the pinhole perforations are not used for an advertising print, but instead for avoiding conventional window in the aircraft. In contrast to conventional windows, the fuselage skin or an outer wall of the aircraft is not broken or not broken on the entire window area. Instead, the fuselage skin is constantly continued, it does therefore not differ between a window surface and a wall surface. The fuselage skin section is provided with a pattern of pinhole perforations which have the effect that a person located within the aircraft can look outside the aircraft.

In other words, the fuselage skin window unit has the advantages that a window unit can be provided in an aircraft without the need of window size cut-outs in the fuselage skin or the aircraft wall. In this way the integrity and continuity of the fuselage skin or the aircraft wall and the load path is maintained. The fuselage skin window unit can transfer structural loads like the surrounding aircraft wall. The shape and size of the fuselage skin window unit can be adapted to the course and the shape of the stringer and frames of the aircraft wall. No additional reinforcements of the window, such as a frame, for example, are necessary. The associated weight and costs are reduced. Finally, the window area within the aircraft can be significantly increased so that e.g. continuous fuselage skin window units at the sides and/or the ceiling of the aircraft can be provided. Even a fully transparent plane is possible. The fuselage skin window unit may even better protect against mechanical influences or shocks from the outside or interior.

The window pane section is transparent and arranged on the pinhole perforations. The window pane section can be one-piece, i.e. made from a single window pane only. This means that the more complicated and more expensive traditional structure of an aircraft window from inner pane, seal and the outer pane is no longer necessary. The window pane section can comprise a retaining element or retainer. The window pane section can be made of glass, plastic or composite material.

The material of the fuselage skin section as such can be opaque, thus making the production and material selection easier. An area of the pattern of pinhole perforations can correspond to the area of a cabin window of the aircraft in order to replace a standard cabin window. The fuselage skin section can comprise a dark surface directed towards an inner surface of the aircraft , so that the pattern of pinhole perforations are less visible for a passenger, a crew member or a pilot.

The holes-to-material ratio of the pinhole perforations can be between 25 and 75% and preferably between 45 and 55%. The hole sizes at a fuselage skin section can be the same or different. The holes may be round or of angular form. The grid or pattern generated by the pinhole perforations on the fuselage skin section can be uniform. Courses, levels or images can be generated be the pinhole perforations.

According to an embodiment the pattern of pinhole perforations has a hole-to-material ratio, which depends on the size of the cabin. This means that depending on the distance between the viewer and the window area the hole-to-material ratio can be selected. In particular, this means that the fuselage diameter and the number and/or the arrangement of the rows of seats can have an influence on the holes-to-material ratio. Furthermore, the diameter of the hole can be selected so that in dependence on the fuselage skin thickness the viewing angle remains as large as possible.

According to an embodiment the pattern of pinhole perforations has a hole diameter between 1.5 and 10 mm and preferably between 2.5 and 7.5 mm. This means that the individual holes to form the pinhole perforations are of said diameter. According to an embodiment the pattern of pinhole perforations has a material width between two adjacent holes which substantially corresponds to the hole diameter. According to an embodiment the pattern of pinhole perforations has a material width between two adjacent holes in the range between 1.5 and 10 mm and preferably between 2.5 and 7.5 mm. The width of the material between two adjacent holes may but need not correspond to the hole diameter.

According to an embodiment the fuselage skin section is directed towards an outer side of the aircraft and the window pane section is directed towards an interior side of the aircraft. This means that the window pane section is inside the aircraft and the fuselage skin section is outside. During flight, the window pane section is pressed outwardly by the cabin interior pressure. According to another embodiment, the window pane section can be directed to an outside of the aircraft while the fuselage skin section is directed to an inner side of the aircraft.

According to an embodiment the fuselage skin section and the window pane section are arranged in such a way that they touch each other. This means that the fuselage skin section and the window pane section lie directly on top of each other and are in contact. According to another embodiment the fuselage skin section and the window pane section may be arranged to be spaced apart from each other. The window pane section and the fuselage skin section can be connected directly or indirectly with each other or can be glued to it.

According to an embodiment the fuselage skin section may comprise a local reinforcement element, such as a local material thickening. The local gain element can run in parallel to stringers and/or frames of the aircraft fuselage and/or can surround the fuselage skin section or the window pane section in a frame-like manner. The reinforcement element can also be an additional element, e.g. a paste-on element.

According to an embodiment the fuselage skin window unit comprises a smoothing surface layer which covers the fuselage skin section (or the window pane section) at an external side of the aircraft. The smooth surface layer can be a stuck transparent film or a composite pane. Using the smoothing surface layer, the fuselage skin window unit can be protected against dirt and an aerodynamically smooth surface can be provided.

In addition, the invention relates to an aircraft with a fuselage skin window unit as described above. The fuselage skin window unit can be used in the side walls and/or the ceiling of the aircraft.

In addition, the invention relates to a method for manufacturing a fuselage skin window unit. The manufacturing process consists of the following steps, not necessarily in this order:

Provide a fuselage skin section and

Provide a window pane section next to the fuselage skin section.

The fuselage skin section is part of a fuselage skin of the aircraft and has a pattern of pinhole perforations. The window pane section is transparent and is arranged to cover the pinhole perforations. The fuselage skin section and the window pane section can be laid on top of each other, plugged to each other, glued to each other or similar.

### BRIEF DESCRIPTION OF THE DRAWINGS

Other features, advantages and application possibilities of the present invention arise from the following description of the exemplary embodiments and the figures. All described and/or depicted characteristics for themselves and in any combination can define the subject matter of the invention also independent of their composition in the individual claims or their dependencies. Identical reference signs in the figures relate to the same or similar objects.

FIG. 1 shows a portion of a passenger cabin of an aircraft with a fuselage skin window unit in a schematic representation.

FIG. 2 shows a side view of an aircraft in a schematic representation.

### DETAILED DESCRIPTION

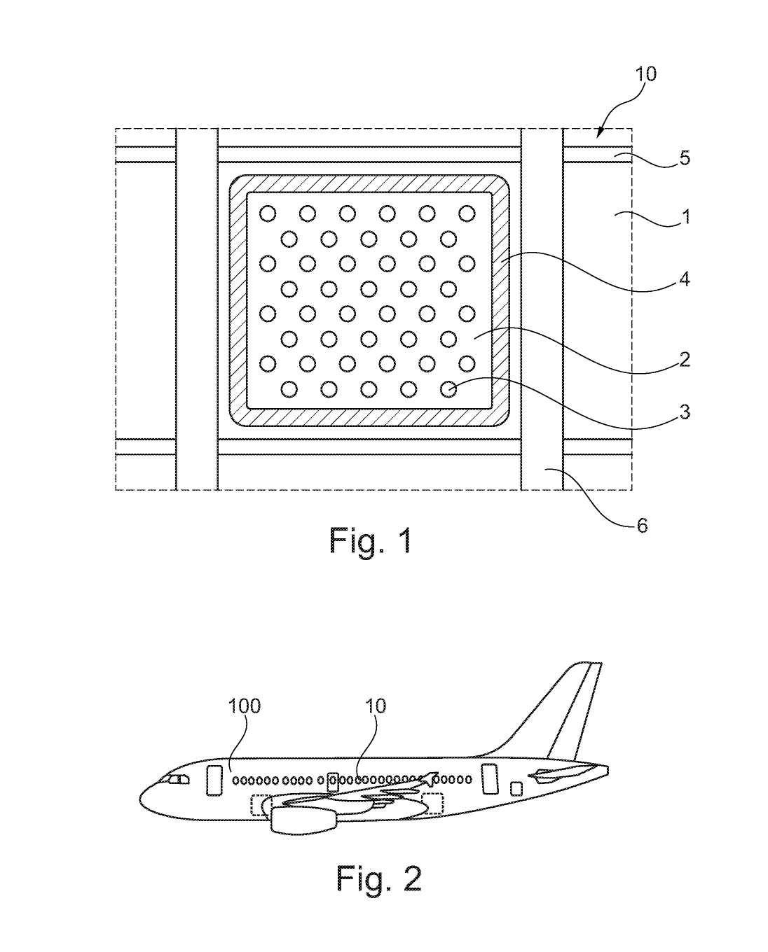

FIG. 1 shows a portion of a passenger cabin of an aircraft 100 (see FIG. 2) with a fuselage skin window unit 10 viewed at from an interior space of the aircraft 100. The fuselage skin window unit 10 includes a fuselage skin section 1 and a window pane section 2. The fuselage skin section 1 is part of a fuselage skin or an exterior wall of an aircraft 100. The fuselage skin section 1 comprises a pattern of pinhole perforations 3. The pattern of pinhole perforations 3 is an arrangement of many small holes in the area in such a way that the holes have the effect that the area appears transparent to a relatively close person. For a more distant person the area will appear opaque. The area of the pattern of pinhole perforations 3 corresponds to the surface of a cabin window of the aircraft 100 as to replace a conventional cabin window.

The window pane section 2 is arranged so that it covers the pinhole perforations 3, i.e. in the FIG. 1 in front of the fuselage skin section 1. The window pane section 2 here is a one-piece, i.e. it only consists of a single window pane instead of inner and outer pane and sealing. Of course, there are also various other window pane assemblies possible. The window pane section 2 includes here a retaining element 4 or retainer. It is of course also possible to have an adhesive surface or similar.

The window pane section 2 is transparent. The window pane section 2 can be made of glass, plastic or a composite material. The material of the fuselage skin section 1 is opaque.

The fuselage skin section 1 is arranged to be directed towards the outside of the aircraft and the window pane section 2 to an inner side of the aircraft 100. The fuselage skin section 1 and window pane section 2 are arranged so that they are contacting each other, i.e. the fuselage skin section 1 and the window pane section 2 lay directly and flat on top of each other and are in contact with each other.

The fuselage skin of the aircraft 100 is not broken through for the fuselage skin window unit 10 at the entire window area. Instead, the fuselage skin including stringers 5 and frames 6 is constantly continued and it is therefore not differed between a window area and a wall area. This has the advantage that the fuselage skin window unit 10 can be provided in an aircraft 100 without having to provide window size cut-outs in the fuselage skin or the aircraft wall. In this way the integrity and continuity of the fuselage skin or the aircraft wall and the load path is maintained.

The skin section 1 has a local material thickening (not shown) as local reinforcement element in parallel to the stringers 5 and the frame 6 of the aircraft fuselage.

The holes-to-material ratio of the pinhole perforations 3 here is 1:3, i.e. approximately 33% of the area are holes and 66% of the surface is material. The hole sizes per skin section 1 are here equal and circular. The diameter of each hole of the pinhole perforations 3 is 1.5 mm here. The width of the material between two adjacent holes is a small multiple of the hole diameter, here at approx. 3 mm. The grid or pattern on the fuselage skin section 1 generated by the pinhole perforations 3 is evenly.

The fuselage skin window unit 10 also includes a smooth surface layer (not shown) which covers the fuselage skin section 1 on the outer side of the aircraft 100, i.e. in FIG. 1 behind the shown layers. Here, the smooth surface is a stuck transparent foil with the support of which the fuselage skin window unit 10 is protected against dirt and an aerodynamically smooth surface is created.

FIG. 2 shows a side view of an aircraft 100 in a schematic representation. The aircraft 100 here is a plane, but can also be a helicopter or any other means of transport. The aircraft 100 includes fuselage skin window units 10 as described above, wherein the fuselage skin window units 10 are included in the side walls of the aircraft 100.

Additionally, it is noted that the word “comprising” does not exclude other elements or steps and the indefinite article “a” or “an” does not exclude a plurality. It is further noted that features or steps which are described with reference to one of the above embodiments can be used in combination with features and steps of other embodiments described above. Reference signs in the claims are not to be deemed as limitation.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A fuselage skin window unit for an aircraft, comprising:
a fuselage skin section; and
a window pane section,
wherein the fuselage skin section is part of a fuselage skin of an aircraft and comprises a pattern of pinhole perforations, and
wherein the window pane section is transparent and arranged to cover the pinhole perforations.

2. The fuselage skin window unit according to claim 1, wherein the fuselage skin section is opaque.

3. The fuselage skin window unit according to claim 1, wherein the fuselage skin section is directed towards an outer side of the aircraft and the window pane section is directed towards an interior side of the aircraft.

4. The fuselage skin window unit according to claim 1, wherein the fuselage skin section and the window pane section are arranged so that they are in contact with each other.

5. The fuselage skin window unit according to claim 1, wherein the pattern of pinhole perforations has a hole diameter between 2.5 and 10 mm.

6. The fuselage skin window unit according to claim 1, wherein the window pane section is formed of a single window pane.

7. The fuselage skin window unit according to claim 1, wherein an area of the pattern of pinhole perforations corresponds to the area of a cabin window of the aviation.

8. The fuselage skin window unit according to claim 1, further comprising a smoothing surface layer covering the fuselage skin section or the window pane section on an outside of the aircraft.

9. An aircraft, comprising a fuselage skin window unit;
wherein the fuselage skin window unit comprises:
a fuselage skin section; and
a window pane section,
wherein the fuselage skin section is part of a fuselage skin of the aircraft and comprises a pattern of pinhole perforations, and
wherein the window pane section is transparent and arranged to cover the pinhole perforations.

10. A method for manufacturing a fuselage skin window unit, comprising the following steps:
providing a fuselage skin section;
providing a window pane section next to the fuselage skin section,
wherein the fuselage skin section is part of a fuselage skin of an aircraft, and comprises a pattern of pinhole perforations, and
wherein the window pane section is transparent and arranged to cover the pinhole perforations.
